(19) United States
(12) Patent Application Publication
(10) Pub. No.: US 2020/0000076 A1
(43) Pub. Date: Jan. 2, 2020

(54) Flexible Glue-on Shoe for Horses, with Unique Tightening Mechanism and Pump Effect in the Sole

(71) Applicant: Equine Fusion AS, Hafrsfjord (NO)

(72) Inventor: Sven Erik Revheim, Stavanger (NO)

(73) Assignee: Equine Fusion AS, Hafrsfjord (NO)

(21) Appl. No.: 16/021,745

(22) Filed: Jun. 28, 2018

(51) Int. Cl. A01L 3/02; A01L 5/00

(52) U.S. Cl. CPC A01L 3/02; A01L 5/00

(57) ABSTRACT

A shoe has a flexible elastic sole and a vamp for fixing the sole to the foot of an animal. The flexible elastic sole has a through-hole in a bottom part thereof for allowing air to be pushed out from an interior space of the shoe when a middle part of the sole is pressed towards the foot. The interior space is defined by a space in between the foot and said sole, and allows air to be sucked in from an exterior of the shoe when the middle part of the sole moves away from the foot under elastic forces acting on the sole.

### FIELD

The present disclosure relates to a shoe for a foot of a hoofed or cloven-hoofed animal, wherein the shoe comprises a flexible elastic sole and a vamp connected to the sole for fixing said sole to the foot of said animal. The present disclosure also relates to a method of mounting a shoe to a foot of a hoofed or cloven-hoofed animal, wherein the shoe comprises a flexible elastic sole and a vamp connected to the sole. Such shoe and method can be advantageously used in both the hobby segment as well as the professional horse sports area.

### BACKGROUND

Metal shoes that are nailed into the hoof are the most commonly used horse hoof protection in the field today. These metals shoes have been used for centuries. Several years ago, new developments were launched into the market. Hoof boots that are not nailed to the hoof but taken on/off as desired has been a hoof protection alternative for many years and are taking an ever increasing market share from the metal shoe. This is also stimulated by an increasing knowledge sharing about and stronger focus on the welfare of the horse.

Another group of shoes that came into the market during these years are the so-called “glue-on” alternatives, which basically are different variations of lower model plastic shoes that are glued on the hoof capsule, which are supposed to last for some weeks.

The current applicant has been active developing horse shoes for many years. Over these years they developed different variations of Velcro/tightening band hoof boots to put on and taken off as needed by the horse owner. Examples of patents disclosing these shoes are: EP2,618,654B1; EP2,257,153A1 and EP2,774,480A1. A common feature for all these models is a flexible rubber sole that has a positive health effect on the horse. This is in great contrast with competitors' products, which distinguish from applicant's models by have a substantially non-flexible/non-elastic sole made of plastic.

Due to its rigidity, the existing glue-on products are requiring different degrees of adaption to get proper fit to the hoof geometry. They put also a clear constraint on the horse, which must be properly stagnant and patient horse during the glue curing process, which can take a long time.

Additionally, the rigid sole material (plastic) in the existing glue-on (and hoof boot) products is limiting the natural hoof deformation during horse movement. Even the “full-sole” versions, which are more comparable with the invention, also entail a closed and unnatural hoof environment (may cause bacteria growth) and is a limiting factor with regards to how long the shoe can be kept glued to the hoof before it has to be removed.

The existing glue-less solutions, however, may suffer from the drawback that they may create sores on the foot of the horse, because of their relative high heights that may rub against sensitive areas of the foot.

In view of the above described problems the present inventor has realized the need to develop shoes for horses. There is a need to try to combine the benefits of each of the solutions that exist.

### SUMMARY

In a first aspect, the present disclosure relates to a shoe for a foot of an animal, wherein the shoe comprises a flexible elastic sole and a vamp connected to the sole for fixing said sole to the foot of said animal, wherein the vamp is configured for being glued with glue to the foot of the animal. Said flexible elastic sole is provided with a through-hole in a bottom part thereof for allowing, in operational use of the shoe, air (or dust, sand, earth or water if any of these are present in the interior space) to be pushed out from an interior space of the shoe when a middle part of the sole is pressed towards the foot. The interior space is defined by a space in between the foot and said sole. The through-hole is further for allowing, in operational use of the shoe, air to be sucked in from an exterior of the shoe when the middle part of the sole moves away from the foot under elastic forces acting on the sole.

The effects of the features of the shoe in accordance with the invention are as follows. First of all, the flexible elastic sole gives a lot of comfort to the animal. Not only does the flexible elastic sole dampen the shocks on the joints of the animal, also it allows for lateral deformation and stretching such that the effective shoe size adapts to the natural deformation of the foot (hoof) of the animal. Additionally, the through-hole in the bottom part of the sole provides for a ventilation of the interior space of the shoe, i.e. in operational use, air will be sucked in an out alternatingly when the animal walks on the ground. This effect is also being referred to as the pumping effect and will be explained in more detail with reference to the figures.

In order to facilitate understanding of the present disclosure one or more expressions are further defined hereinafter.

Wherever the wording “vamp” is used, this must be interpreted as the whole upper part of the shoe (may be referred to as the fixation part), that is connected with the sole and which function is to mount the sole to the animal. As will be explained with reference to the figures, the vamp may be comprise a plurality of features.

Wherever the wording “animal” is used, this must be interpreted as all hoofed and cloven-hoofed animals, including horses, ponies, mules, donkeys, and the like. That the application has a strong focus on horses does not mean that other animals are excluded.

Wherever the word “foot” is used, this must be interpreted as the far end of leg of the animal, also being referred to as the hoof of the animal.

In an embodiment of the shoe in accordance with the present disclosure, the sole is provided with at least two through-holes in said bottom part, wherein said through-holes are distributed over said middle part of the bottom part. Providing multiple through-holes may be beneficial for the ventilation of the interior space. In addition, the size of the hole may be adapted to provide the desired pumping effect in terms of damping of the movement of the middle part of the sole relative to the foot. Said holes may have any desired shape.

In an embodiment of the shoe, the vamp is configured for holding said foot of said animal and is provided with a tightening means enabling the shoe to stay on the foot even when lifted. Proper tightening of the shoe to the foot is not only important during operational use, but also during mounting of said shoe as will be explained with reference to the method claims.

In an embodiment, said vamp comprises at least two eyelet tabs and a tongue. The use of eyelet tabs and a tongue, as is known from shoes for humans, provides for a convenient fixation, and opens up the opportunity to tighten the shoe with various different techniques.

In an embodiment, the vamp comprises a tightening device selected from a group consisting of: one or more shoe laces, one or more tie ribs, one or more ropes and one or more rotary tightening knobs. This group of techniques forms an important part of the different possibilities of tightening the shoe. The invention is explicitly not limited to any one of these techniques.

In a second aspect, the present disclosure relates to shoe for a hoof/foot of an animal, wherein the shoe comprises a flexible elastic sole and a vamp connected to the sole for fixing said sole to the foot of said animal, wherein the vamp is configured for being glued to the foot of the animal, wherein the vamp is configured for holding said foot of said animal and is provided with a tightening means enabling the shoe to stay on the foot even when lifted. The inventors are the first to combine the flexible elastic sole shoes with the glue-on technology, which leads to enormous benefits in the method of mounting the shoe to the animal.

In a third aspect, the present disclosure relates to a method of mounting a shoe to a foot of an animal, wherein the shoe comprises a flexible elastic sole and a vamp connected to the sole, wherein the vamp is configured for being glued with glue to the foot of the animal. The method comprises steps of:
providing the shoe;
providing glue on the inside of the vamp the shoe;
mounting the shoe on the foot of said animal such that the glue contacts the foot;
tightening the shoe such that it stays on the foot even when lifted or moved by the animal prior to full curing of said glue, and
allowing the animal to move before the glue is fully cured.

The inventors are the first to effectively combine a shoe having a flexible sole with a glue-on technology. Instead of keeping the horse still right after glue-shoe application (typically 15-30 minutes), the animal is allowed to move pretty freely right after application (it will be kept a short time in a controlled environment not allowing for high activity/speed) due to the tightening function. The reason is that the tightening function takes over part of the function of the glue, which no longer needs to be fully cured before the animal is allowed to move. Expressed differently, in certain examples, the horse does not need to be restrained in movement as is common for the prior art methods. This leads to an enormous gain in time, but also in comfort for the animal.

In an embodiment of the method, the tightening is done by means of one of a group consisting of: one or more shoe laces, one or more tie ribs, one or more ropes and one or more rotary tightening knobs. This group of techniques forms an important part of the different possibilities of tightening the shoe. The invention is explicitly not limited to any one of these techniques.

In an embodiment of the method, in the step of providing the shoe, a shoe in accordance with the invention is provided. When a shoe is used having a through-hole in accordance with the first aspect of the invention, this facilitates the mounting of the shoe even more.

In an embodiment of the method, said steps are repeated for each foot of said animal.

### BRIEF INTRODUCTION OF THE DRAWINGS

In the following is described an example of a preferred embodiment illustrated in the accompanying drawings, wherein:

FIG. 1 shows a perspective view of a sole of a shoe in accordance with the present disclosure;

FIG. 2 shows a perspective view of the bottom side of the sole of FIG. 1;

FIG. 3 shows a cross-sectional view of the sole of FIG. 1;

FIG. 4 shows a bottom view of the sole of FIG. 1;

FIGS. 5a-5c illustrate the pumping effect in accordance with an embodiment of the present disclosure, and

FIGS. 6-9 show different stages of the method of mounting a shoe in accordance with an embodiment of the present disclosure.

### DETAILED DESCRIPTION OF THE EMBODIMENTS

Various illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various systems, structures and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

A purpose of the present inventor is combine to the benefits of existing horse shoes and to further improve the shoe, where possible.

The existing alternatives for horse shoes on the market do not offer a pre-tension option to ease the application process by holding the shoe in proper and tight position during glue drying process. This requires the owner to ensure proper fit/tension manually during the glue drying process (not user-friendly and not horse-friendly).

The competitive glue-on shoe products available on the market are made of rigid plastic material, resulting in limited natural hoof functioning due to lack of elasticity/adaptability and thus dampening effect (results in stress on joints and ligaments). The “full-sole” protection options do not offer a pump effect feature as the current invention does, that may in many cases result in an unhealthy hoof environment over time, limiting the lifetime of the shoe (has to be taken off earlier than desired).

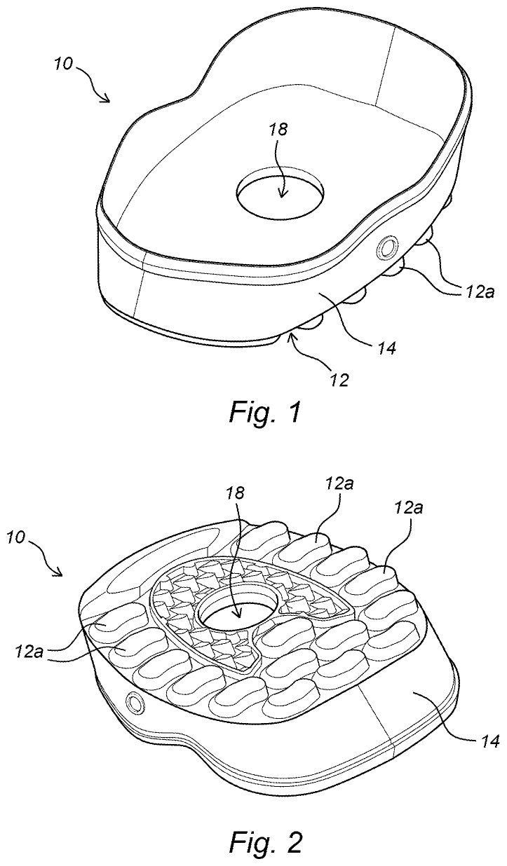

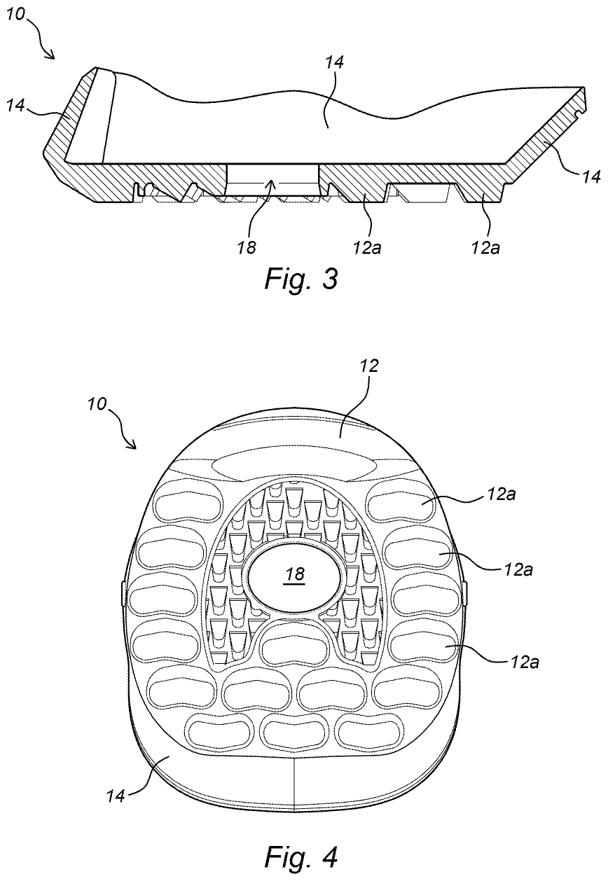

FIG. 1 shows a perspective view of a sole 10 of a shoe in accordance with the present disclosure. FIG. 2 shows a perspective view of the bottom side of the sole 10 of FIG. 1. FIG. 3 shows a cross-sectional view of the sole of FIG. 1. FIG. 4 shows a bottom view of the sole of FIG. 1. The sole 10 is made of flexible elastic material, such as rubber, and comprises a bottom part 12 and a sole sidewall 14 connected to the bottom part 12. The bottom part 12 comprises a profile (patterned structure) 12a at the bottom side thereof to increase grip between the shoe and the ground, and to provide damping. The profile 12a comprises a plurality of studs. However, the design of the profile 12a as such is considered known to the person skilled in the art.

What is very characteristic for the sole in FIGS. 1 to 4 is the through-hole 18, which is provided in the bottom part 12 of the sole 10. This through-hole 18 provides for a significant benefit for the animal, such as a horse for example. FIG. 3 clearly shows that the sole 10 defines a space within the sole sidewalls 14 for receiving the foot (hoof) of the animal. The figure also illustrated that the through-hole 18 provides access to the underside of the hoof.

It must be stressed at this point that, even though the through-hole 18 constitutes an advantageous embodiment, the invention is not limited to the glue-on flexible sole shoe shown in the drawings. Also, without the through-hole there is a significant gain in the method of mounting the shoe.

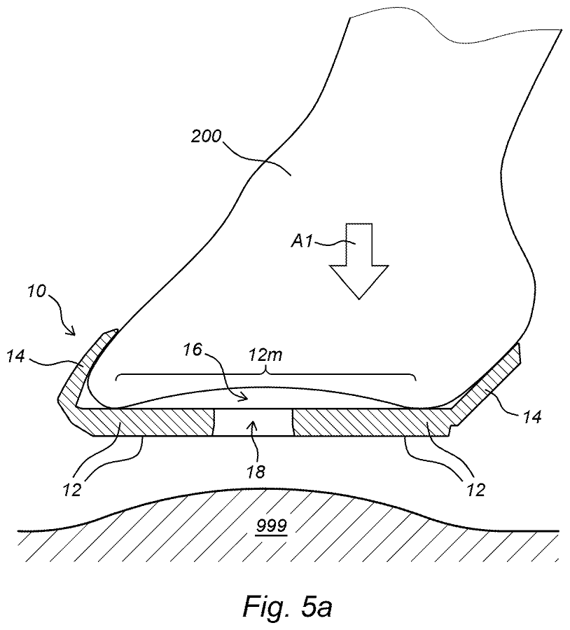

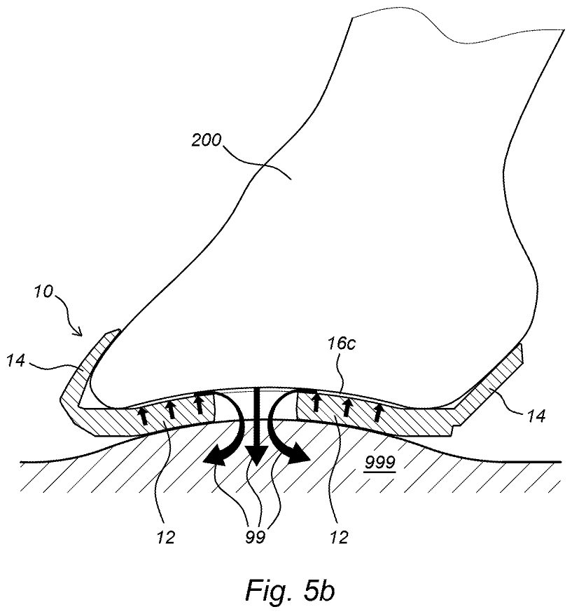

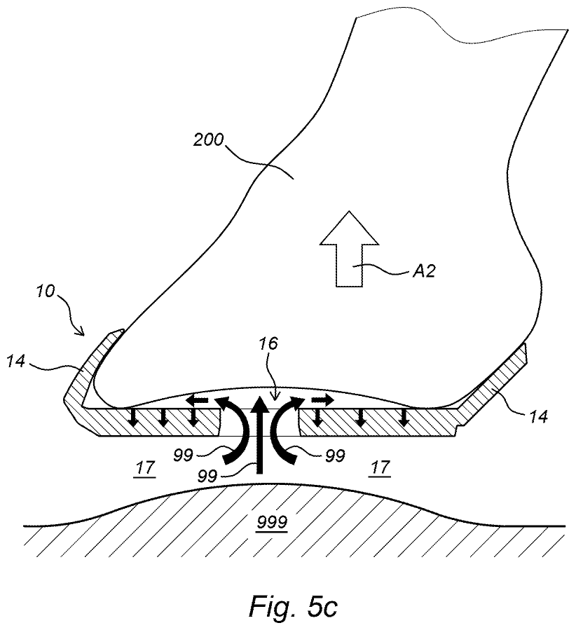

FIGS. 5a-5c illustrate the pumping effect in accordance with an embodiment of the invention. In all figures there is shown a hoof 200 of a horse In FIG. 5a having a shoe in accordance with the present disclosure mounted thereon. For simplicity reasons only the sole 10 has been shown.

In FIG. 5a the hoof 200 of the horse is moving downward in the direction of the ground 999 as illustrated by the downward point arrow A1. The ground 999 has irregularities as illustrated curved surface caused by the little bump. FIG. 5 also illustrates that the hoof 200 does not necessarily have a flat bottom surface but may be a bit concave in the middle part thereof for most animals. In equilibrium the sole 10 is not bent, thereby defining an interior space 16 between the hoof 200 and the bottom part 12 of the sole 10 as illustrated. The earlier discussed through-hole 18 is provided in the middle part 12m of the bottom part 12 as illustrated and thereby provides access to the interior space 16. In the interior space 16 there is air present in this stage.

In FIG. 5b the hoof 200 of the horse is placed on the ground 999 and the bottom part 12 of the flexible elastic sole 10 has bend to follow the curvature of the ground 999. As a consequence of this the interior space 16 has been compressed and become a compressed interior space 16c as illustrated. The air 99 that was inside the interior space 16 in FIG. 1 is being pressed out as illustrated by the fat arrows. The sole 10 together with the hoof 200 effectively acts as a pump in this stage of the process.

In FIG. 5c the hoof 200 of the horse is being lifted up from the ground 999 as illustrated by the upward-pointed arrow A2. Because of the flexibility and elasticity of the bottom part 12 of the sole 10 it has turned back to its original flat shape and the air 99 has been sucked into the interior space 16 that also returned to its original shape as illustrated. The air 99 flows from the exterior 17 of the shoe to the interior space 16 of the shoe as illustrated by the fat arrows. The repetition of the steps as illustrated by FIGS. 5a to 5c, as is the case when the horse walks causes continues refreshing (by pumping in and out) of the air inside the shoe, which results in a significant health gain for horse.

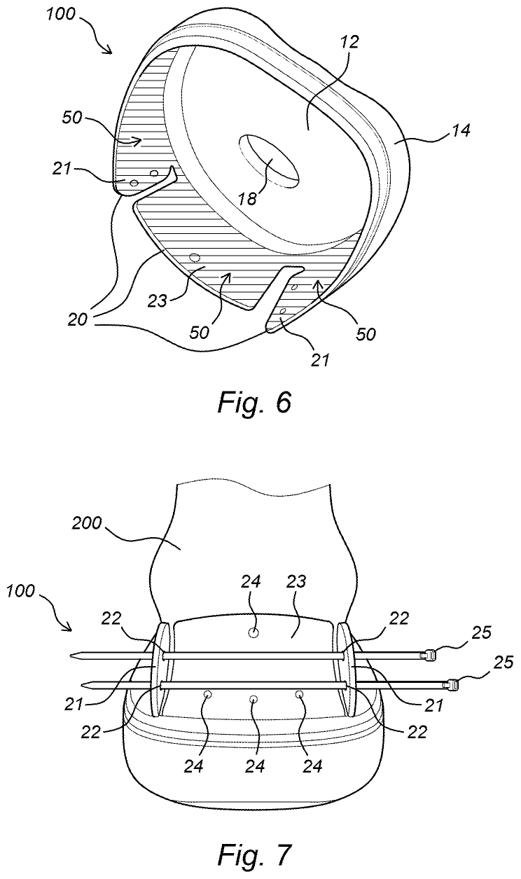

FIGS. 6-9 show different stages of the method of mounting a shoe 100 in accordance with an embodiment of the present disclosure. The difference between these figures and the previous figures is that the shoe 100 is now completed with a vamp 20 attacked to the sole 10 as can be seen in FIG. 6. This vamp 20 is typically made of leather and stitched to the sole 10. It may alternatively comprise synthetic material. As is also common for shoes for humans is that the vamp 20 in this embodiment comprises two eyelet tab 21 and a tongue 23.

In the stage of FIG. 6 the shoe 100 is provided with glue 50 on the side of the vamp 20 as illustrated by the shaded areas. The glue 50 and the provision of the glue 50 as such is considered to be well-known in the field and will not be discussed in detail.

In the stage of FIG. 7 the shoe 100 is put on the foot (hoof) 200 of the horse. The figure shows also eyelets 22 in the eyelet tab 21 through which tie ribs 25 are stuck. The tongue 23 is also provided with holes 24, which serve for facilitating attachment of the glue to the shoe.

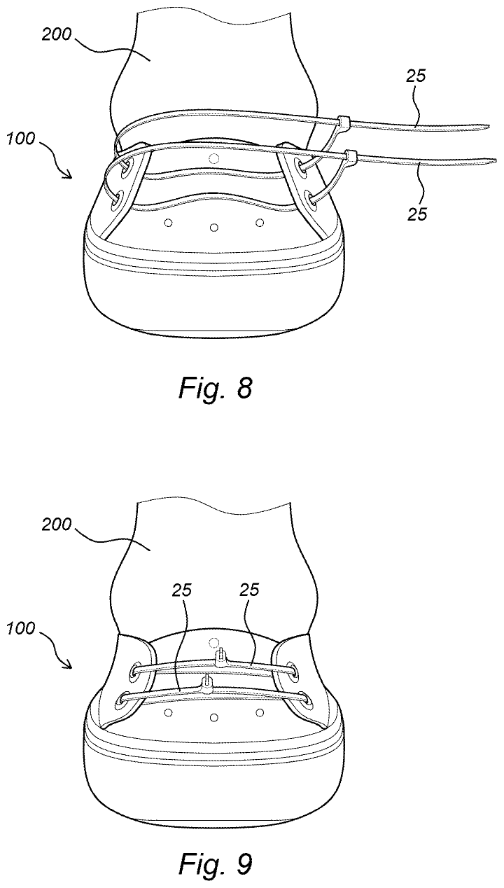

In the stage of FIG. 8 the tie ribs 25 are further prepared for tightening the shoe 100 by sticking their respective ends through their holes as illustrated.

In the stage of FIG. 9 the tie ribs 25 tightened such that the shoe 100 is properly kept on the hoof 200 of the horse, even when the glue is not yet dry. After tightening the tie ribs 25 are cut off as illustrated. It must be noted that the use of tie ribs 25 is just one way of tightening the shoe 100 to the hoof 200. The invention is not limited to any one of such tightening techniques. The use of tie ribs 25 seems promising because of low costs.

After the stage of FIG. 9 the next hoof 200 of the horse can be provided with a shoe and after the last shoe the horse can be quickly allowed to move because the tightening system keeps the shoe in place, while the glue further dries. This leads to a significant time gain, compared to the prior art shoes and mounting techniques.

The particular embodiments disclosed above are illustrative only, as the invention may be modified and practiced in different but equivalent manners apparent to those skilled in the art having the benefit of the teachings herein. For example, the method steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage. In the device claims enumerating several means, several of these means may be embodied by one and the same item of hardware.

1. A shoe for a foot of an animal, wherein the shoe comprises a flexible elastic sole and a vamp connected to the sole for fixing said sole to the foot of said animal, wherein the vamp is configured for being glued with glue to the foot of the animal, wherein said flexible elastic sole is provided with a through-hole in a bottom part thereof for allowing, in operational use of the shoe, air to be pushed out from an interior space of the shoe when a middle part of the sole is pressed towards the foot, wherein the interior space is defined by a space in between the foot and said sole, and for allowing, in operational use of the shoe, air to be sucked in from an exterior of the shoe when the middle part of the sole moves away from the foot under elastic forces acting on the sole.

2. The shoe according to claim 1, wherein the sole is provided with at least two through-holes in said bottom part, wherein said through-holes are distributed over said middle part of the bottom part.

3. The shoe according to claim 1, wherein the vamp is configured for holding said foot of said animal and is provided with a tightening means enabling the shoe to stay on the foot even when lifted or moved by the animal prior to full curing of said glue.

4. The shoe according to claim 3, wherein said vamp comprises at least two eyelet tabs and a tongue.

5. The shoe according to claim 4, wherein the vamp comprises a tightening device selected from a group consisting of: one or more shoe laces, one or more tie ribs, one or more ropes and one or more rotary tightening knobs.

6. A shoe for a foot of an animal, wherein the shoe comprises a flexible elastic sole and a vamp connected to the sole for fixing said sole to the foot of said animal, wherein the vamp is configured for being glued with glue to the foot of the animal, wherein the vamp is configured for holding said foot of said animal and is provided with a tightening means enabling the shoe to stay on the foot even when lifted or moved by the animal prior to full curing of said glue.

7. A method of mounting a shoe to a foot of an animal, wherein the shoe comprises a flexible elastic sole and a vamp connected to the sole, wherein the vamp is configured for being glued to the foot of the animal, the method comprising:
providing the shoe;
providing glue on the inside of the vamp the shoe;
mounting the shoe on the foot of said animal such that the glue contacts the foot;
tightening the shoe such that it stays on the foot even when lifted or moved by the animal prior to full curing of said glue, and
allowing the animal to move before the glue is fully cured.

8. The method according to claim 7, wherein the tightening is done by one of a group consisting of: one or more shoe laces, one or more tie ribs, one or more ropes and one or more rotary tightening knobs.

9. The method according to claim 7, wherein the vamp is configured for being glued with glue to the foot of the animal, wherein said flexible elastic sole is provided with a through-hole in a bottom part thereof for allowing, in operational use of the shoe, air to be pushed out from an interior space of the shoe when a middle part of the sole is pressed towards the foot, wherein the interior space is defined by a space in between the foot and said sole, and for allowing, in operational use of the shoe, air to be sucked in from an exterior of the shoe when the middle part of the sole moves away from the foot under elastic forces acting on the sole.

10. The method according to claim 7, wherein said steps are repeated for each foot of said animal.
